(19) United States
(12) Patent Application Publication
(10) Pub. No.: US 2019/0163470 A1
(43) Pub. Date: May 30, 2019

(54) SKILLS IDENTIFICATION FOR SOFTWARE PRODUCTS

(71) Applicant: International Business Machines Corporation, Armonk, NY (US)

(72) Inventors: Darren R. Beard, Chandlers Ford (GB); Jenny J. He, Chandlers Ford (GB); Andrew Wright, Chandlers Ford (GB); Colin R. Penfold, Ropley (GB)

(21) Appl. No.: 15/822,436

(22) Filed: Nov. 27, 2017

(51) Int. Cl. G06F 9/44

(52) U.S. Cl. CPC G06F 8/73

(57) ABSTRACT

A method, system, and computer program product for identifying skills for product areas includes: receiving change data from a first computing device, the change data including at least change sets, check-in history, and product areas; analyzing the change data to determine dimensions of change, the dimensions of change including at least a size of change, an age of change, and a quantity of changes; calculating a program skill level for each program of one or more programs using the dimensions of the change, the software product having one or more product areas, each product area having one or more programs; calculating a product skill level for each product area of the one or more product areas using the calculated program skill levels for each program; and providing an output having a visual representation of the skill level for each product area.

### BACKGROUND

The present disclosure relates to skills identification, and more specifically to using change data to calculate skills levels for product areas.

Large software products can contain hundreds or thousands of individual programs, each of which performs specialized functions. A program may be a collection of instructions for a computer system to perform tasks. Each program is written, or coded, by a programmer (i.e., an individual with programming knowledge and abilities). Additionally, each program can be further developed, meaning that once the initial writing is completed, each program is further documented, tested, debugged, in order to maintain the software product.

### SUMMARY

The present invention provides a computer-implemented method, system, and computer program product to identify skills for product areas. The method may include receiving change data from a first computing device, the change data including at least change sets, check-in history, and product areas. The method may also include analyzing the change data to determine dimensions of change, the dimensions of change including at least a size of change, an age of change, and a quantity of changes, where the change is a change made to a software product. The method may also include calculating a program skill level for each program of one or more programs using the dimensions of the change, the software product having one or more product areas, each product area having one or more programs. The method may also include calculating a product skill level for each product area of the one or more product areas using the calculated program skill levels for each program. The method may also include providing an output having a visual representation of the skill level for each product area.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a flowchart of a set of operations for determining skill levels for product areas, according to various embodiments.

FIG. 2 depicts a block diagram of an example computer system for determining skill levels, according to various embodiments.

FIG. 3 depicts a block diagram of an example computer system for determining skill levels, according to various embodiments.

FIG. 4 depicts a schematic diagram of a sample skills map, according to various embodiments.

FIG. 5 depicts a schematic diagram of a sample skills breakdown, according to various embodiments.

FIG. 6 depicts a block diagram of a sample computer system for implementing operations for determining skill levels, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to skills identification, and more specifically to using change data to calculate skills levels for product areas. While the present disclosure is not necessarily limited to such applications, various aspects of the disclosure may be appreciated through a discussion of various examples using this context.

Programs within a software product may be maintained and developed by a number of people over a period of time, potentially over decades. Maintaining and developing programs may include writing, designing, documenting, testing, debugging, etc. With all the different areas involved in maintaining and developing programs, as well as the time spent on the maintaining and developing, it is unlikely that any one person will know and understand all the details of product areas within a software product. Further, with the programs and software products continually being maintained and developed throughout their life span, individuals may move on from the development (e.g., change jobs, move to other projects, retire, etc.), making it difficult to track personnel working on each program as well as the skill level of the personnel for each program. It may also be difficult to determine the correct personnel to assign new work, such as new development work or customer reported problems, among the various programs. Thus, with the difficulties to identify skill levels and the correct personnel to assign the work, service may experience increased delays and costs, which may lead to a decrease in customer satisfaction.

Various methods are used to try and maintain a mapping between product areas and personnel with knowledge of the areas. The methods may include having personnel provide their area, and level, of expertise and then compile the information in a spreadsheet or table. With the changes in personnel the information may require almost constant updating, and because the updating is done manually, the mapping may quickly become out of date. Additionally, with the personnel providing their own level of expertise, the levels may not be accurate because each personnel may have their own expert standard. For example, one personnel may identify themselves as an expert after working on a product area for 5 years but another personnel may identify themselves as an expert after working on a product area for 1 year. Therefore, the data collected and recorded in order to create and maintain the mapping between product areas and personnel may have discrepancies and, thus, may not be accurate.

The present disclosure provides a computer-implemented method, system, and computer program product for identifying skills and skill levels for product areas. The skill levels may be a general skill level for a product area or may include skill levels for personnel within the product area. Change set details of a software product as well as the amount of code changes, and in which product areas the changes are made, are used to determine the skill levels. This may enable the system to track and maintain data for the skill levels of product areas as well as the product skill areas, and skill levels, of the personnel (e.g., coders, programmers, designers, etc.). In various embodiments, the present disclosure provides an automated process for identifying the skills and skill levels for product areas. The skill levels may be generated, or calculated, dynamically and accurately in real time. Generating the skill levels may be an automated process, thus providing the data without errors (e.g., human discrepancies) and delays, and removing the need for personnel to manually execute steps of the process.

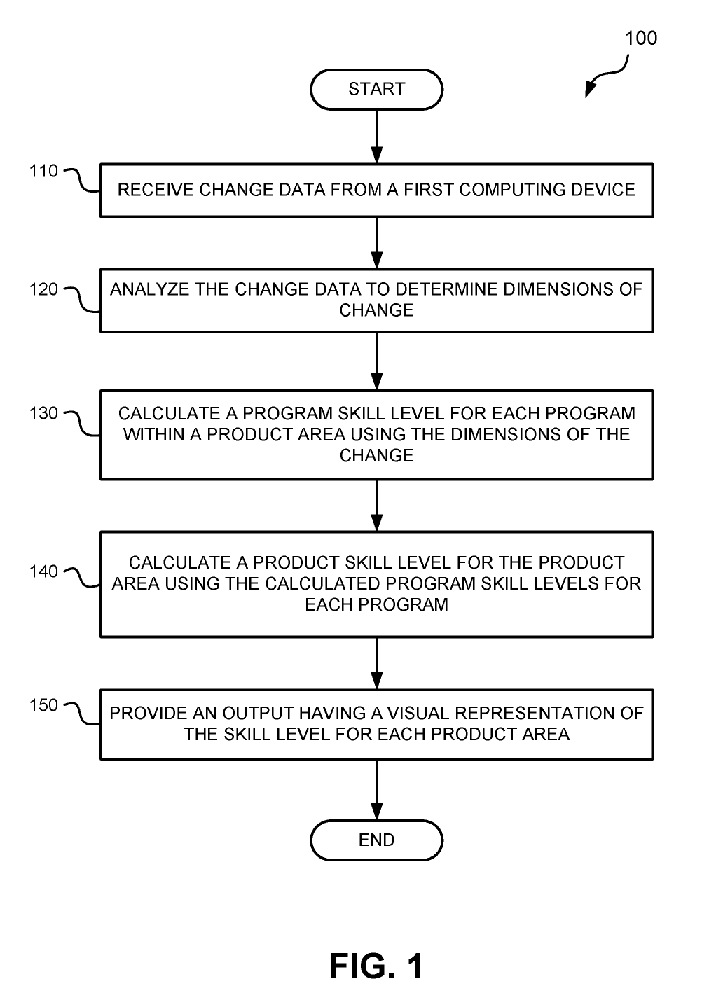

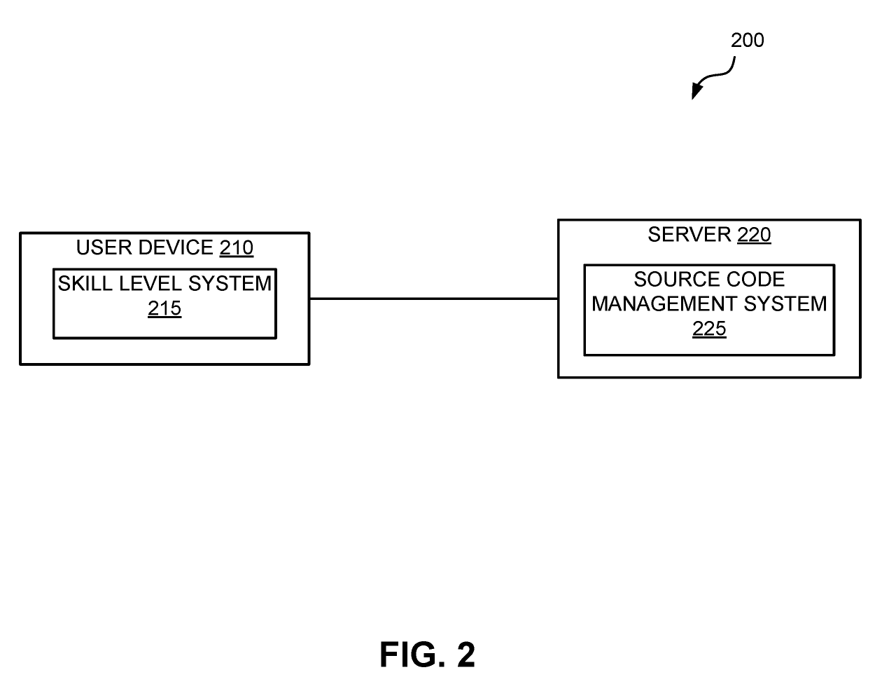

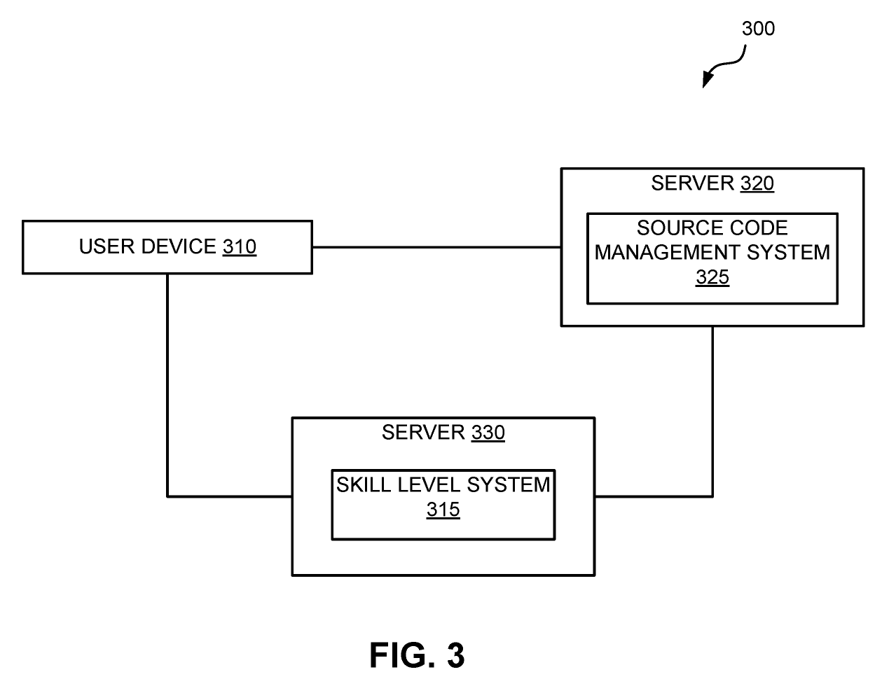

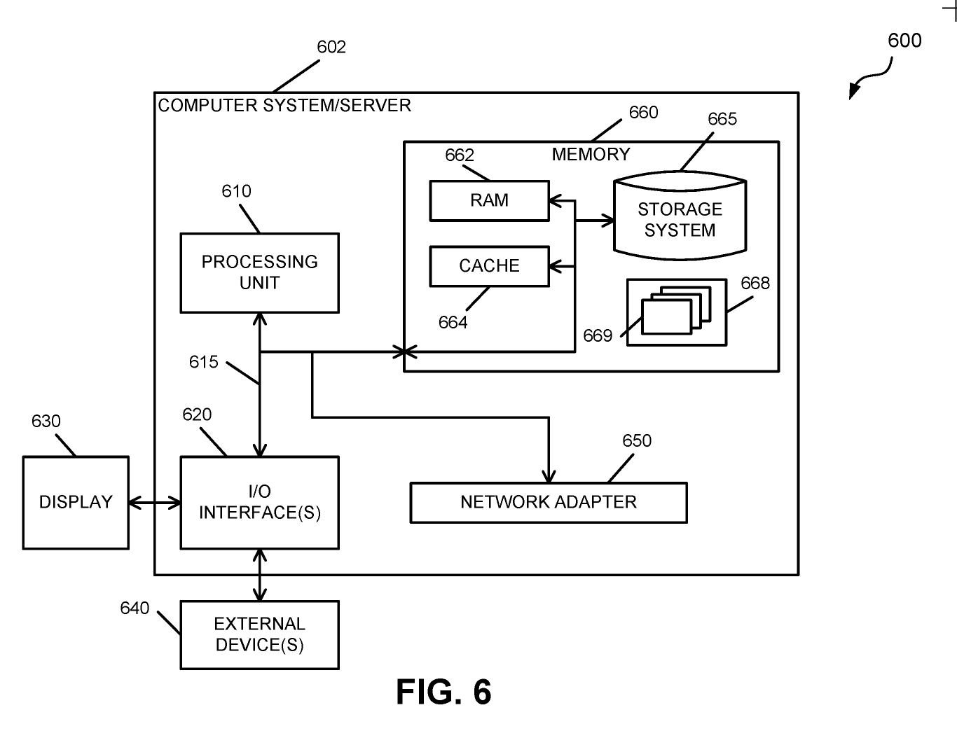

Referring now to FIG. 1, a flowchart illustrating a method 100 for determining skill levels for product areas is depicted, according to various embodiments. In an embodiment, the method 100 is implemented as a computer script or computer program (e.g., computer executable code) to be executed by a server, such as server 330 (FIG. 3), on or connected to, a computer system, such as computer system 200 (FIG. 2), computer system 300 (FIG. 3), or computer system 600 (FIG. 6). In various embodiments, the server is a computer device, such as user device 210 (FIG. 2) or computer system/server 602 (FIG. 6).

In various embodiments, a server is configured to execute operation 110 to receive change data from a first computing device. Change data may include change sets, check-in history, and product areas. Change sets may be a set or grouping of changes to code of a software product, or in some cases changes to the code of a product area or program within a software product. In some embodiments, checking-in is returning data and a record of the returned data. For example, if a user (e.g., a programmer) made changes to a software product, the user would check-in the data once done modifying the data. Check-in history may include a history of previous check-ins made to a software product, a product area, or a program. In various embodiments, product areas are areas of focus within a software product. Example product areas include core functions, networking, web services, performance, data management, diagnostics, terminal control, workload management, security, recovery, web services, kernel, etc. Product areas may be further discussed herein.

In some embodiments, the change data is received from a source code management system (e.g., Rational Team Concert™ (RTC)). The source code management system may be separate from the server. In other embodiments, the source code management system is within the server. Sample computer systems and computer system layouts are further discussed herein and depicted in FIG. 2, FIG. 3, and FIG. 6.

Receiving the change data may include requesting information, including at least the change data, from the first computing device (e.g., the source code management system). In some embodiments, the first computing device provides an application programming interface (API) to extract the change data.

In various embodiments, a server is configured to execute operation 120 to analyze the change data to determine dimensions of change. The dimensions of change may include size of change, age of change, and quantity of changes. In some embodiments, size of change may be the number, or quantity, of lines of code (e.g., source code) being changed. The age of change may be a length of time (e.g., years, months, days, etc.) since the change has occurred. The quantity of changes may be a number, or quantity, of programs changed within a product area. In various embodiments, change is a change made to a software product.

In some embodiments, analyzing the change data may include compiling and sorting the change data by product area, and by program within the product area. In other embodiments, analyzing the change data may include compiling and sorting the change data by product area, and by user (e.g., personnel, programmer, coder, etc.) within the product area.

In various embodiments, a server is configured to execute operation 130 to calculate a program skill level for each program within a product area using the dimensions of the change. A software product may have one or more product areas, and each product area may have one or more programs. In some embodiments, the skill level of a program may be a sum of the ratio of a size of change and an age of change for each user (e.g., programmer, designer, debugger, etc.) of the program.

In various embodiments, the skill level for a program can be calculated using the following equation:

$$skill level of a program = \sum \frac{( size of change )}{( age of change )}$$

The skill level of a program may be a sum of the ratio of a size of change and an age of change for each module of the program, in various embodiments. The ratio of size of change and age of change for a module may be referred to herein as a module skill level. Each program may have one or more modules, where a module may be an area of interest within a program. Modules may be incorporated into the program using interfaces. The size of change may be expressed as a percentage, fraction, or decimal of the module changed. For example, when 50 lines of code in a 100 line module are changed, the size of change may be 50%, ½, or 0.5. In another example, when 50 lines of code in a 1000 line module are changed, the size of change may be 5%, 1/20, or 0.05. In various embodiments, the age of change is expressed in months. In an example, the age of change may be 5 months. Continuing the previous examples, the module skill level may be a ratio of 0.5 to 5 months, or 0.1. In another example, the module skill level may be 0.05/5 months, or 0.01. The module skill level may be expressed as a number, a decimal, a ratio, a fraction, a percentage, etc. In some embodiments, the larger the size of change, the higher the skill level of the module. Further, the smaller the age of change, or the more recent the change, the higher the skill level of the module.

In some embodiments, each module may have a weighting factor. The weighting factor may indicate an importance of the module or may indicate a difficulty of the programming for the module (i.e., degree of difficulty). In some embodiments, when the weighting factor indicates a difficulty of the programming for the module, the weighting factor may be a code weight, with different factors set for various types of programming. For example, development work may have a code weight of 1, defect fixes may have a code weight of 5, and service fixes may have a defect weight of 25. In some embodiments, when the weighting factor is an importance of the module, the weighting factor is an importance weight, with different factors set for various levels of importance. In various embodiments, weighting factors are preset values. In other embodiments, weighting factors are calculated by analyzing the change data and using statistical analysis.

Calculating the program skill level may include determining at least a size of change and age of change for each module of a program. Then a weighting factor may be determined for each module, as discussed herein. A module skill level may be calculated using the size of change and age of change for the module, as well as the weighting factor. The module skill level may be calculated by finding the ratio of the size of change and age of change of the module and then multiplying the ratio by the weighting factor. For example, the ratio of the size of change and age of change is 0.5 (determined from a previous example herein) and the weighting factor is 5 (the code may be defect fixes having a code weight of 5). In this example, the module skill level may be 2.5. In various embodiments, the module skill level represents an amount of skill of a module. Calculating the program skill level may further include calculating a summation of the module skill levels for each module, to determine an overall skill level for the program. This method may be repeated for each program of a product area.

In various embodiments, the skill level of a program is a sum of the ratio of a size of change and an age of change for each user of the program. As discussed herein, users may include programmers, designers, developers, debuggers, etc. of the program. The size of change may be expressed as a percentage, fraction, or decimal of the amount of code changed by a user. For example, a user changes 50 lines of code in a 1000 line program (or module). The size of change may be 5%, 1/20, or 0.05.

In some embodiments, each user has a weighting factor, indicating a difficulty of the programming of the user or indicating an importance of the program or module the user is changing. For example, one user may be doing development work, development work having a weighting factor of 1, and another user may be doing service fixes, service fixes having a weighting factor of 25. In various embodiments, weighting factors are preset values. In other embodiments, weighting factors are calculated by analyzing the change data and using statistical analysis.

Calculating the program skill level may include determining a size of change and an age of change for each user of the program. Then a weighting factor may be determined for each user, as discussed herein. A user skill level may be calculated using the size of change and age of change for the user, as well as the weighting factor. The user skill level may be calculated by finding the ratio of the size of change and the age of change for the user, and then multiplying the ratio by the weighting factor. For example, the ratio of the size of change and age of change is 0.05 (determined from a previous example herein) and the weighting factor is 25, as the change by the user is service fixes. In this example, the module skill level may be 1.25. Calculating the program skill level may further include calculating a summation of the user skill levels for each user of the program, to determine an overall skill level for the program. This may be repeated for each program of a product area.

In some embodiments, when users of the program include at least designers and coders of the program, the change data may further include subjective skill data for each user. Subjective skill data may be data inputted by each user indicating their skill level in various program focus areas or modules. In some embodiments, the subjective skill data is received from the first computing device. In other embodiments, the subjective skill data is received from a third computing device, separate from the first computing device. The subjective skill data may include skill levels in areas such as design and debugging, because these areas may not have a high weighting factor as they do not include coding with high levels of difficulty. Areas such as design and debugging may have numerous challenges and difficulties that should be reflected in a weighting factor, but may not be reflected using the methods discussed herein. By receiving subjective skill data inputted by each user, the difficulties, the weighting factors, and further the user skill level may be more accurately reflected. In various embodiments, calculating the program skill level includes determining the subjective skill data for each user of the program, and calculating the user skill factor for each user further using the subjective skill data. In some embodiments, the subjective skill data is used to determine the weighting factor.

In various embodiments, a server is configured to execute operation 140 to calculate a product skill level for the product area using the calculated program skill levels for each program. In various embodiments, the skill level for a program can be calculated using the following equation:

skill level of a product area=Σ skill level of a program

The skill level of a product area may be calculated by taking a summation of the skill levels of each program within the product area. The skill levels of each program may be calculated as discussed herein.

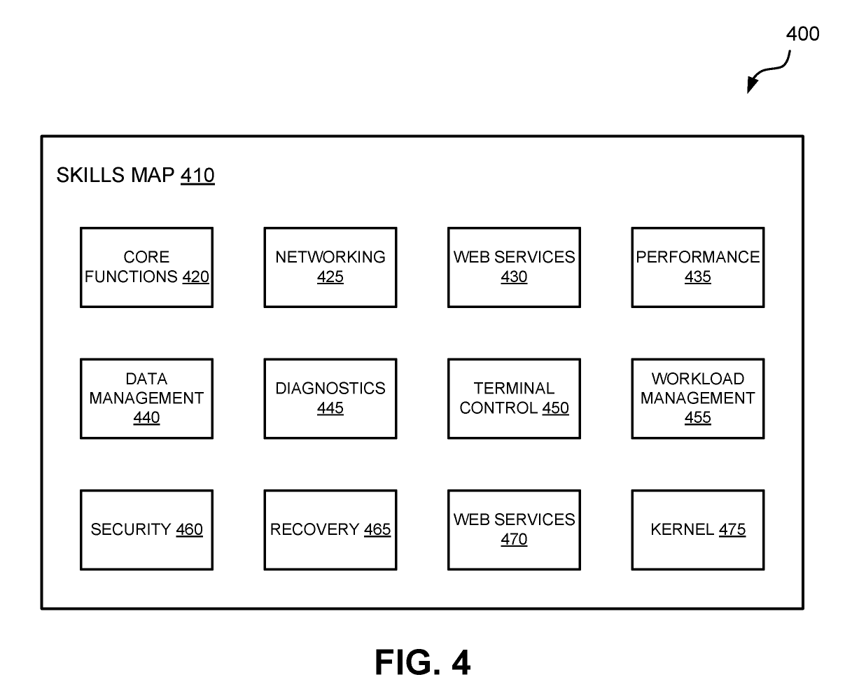

In various embodiments, a server is configured to execute operation 150 to provide an output having a visual representation of the skill level for each product area. The output may further include a recommendation of users for at least one of each program and each product. The recommendation of users may indicate one or more users with a high user skill level. The recommendation of users may include users with a skill level above a threshold skill level, in some embodiments. In other embodiments, the recommendation of users includes users with the highest, or highest few, skill levels. In some embodiments, the recommendation of users may be included within the visual representation. The visual representation may be a skills map, such as skills map 410, in various embodiments. The skills map 410 is further discussed herein and depicted in FIG. 4.

Referring to FIG. 2, a block diagram of an example computer system 200 for determining skill levels is depicted, according to various embodiments. System 200 is one possible computer system capable of determining skill levels and is illustrated for example purposes.

System 200 may include a user device 210 and a server 220. User device 210 may communicate with server 220 via any suitable network (e.g., local area network, wide area network, etc.). In various embodiments, the user device 210 includes a skill level system 215. Skill level system 215 may be configured to execute method 100 (FIG. 1). Server 220 may include a source code management system 225. In various embodiments, user device 210 and server 220 reside in the same system.

Referring to FIG. 3, a block diagram of an example computer system 300 for determining skill levels is depicted, according to various embodiments. System 300 is one possible computer system capable of determining skill levels and is illustrated for example purposes.

In various embodiments, system 300 includes a user device 310, a server 320, and a server 330. The server 320 may include source code management system 325. The server 330 may include skill level system 315. In some embodiments, skill level system 315 executes method 100 (FIG. 1). Skill level system 315 may transmit an output to user device 310, and user device 310 may display a visual representation of the skill factor for each product area.

Referring to FIG. 4, a schematic diagram 400 of a sample skills map 410 is depicted, according to various embodiments. Skills map 410 is one possible visual representation and is illustrated for example purposes.

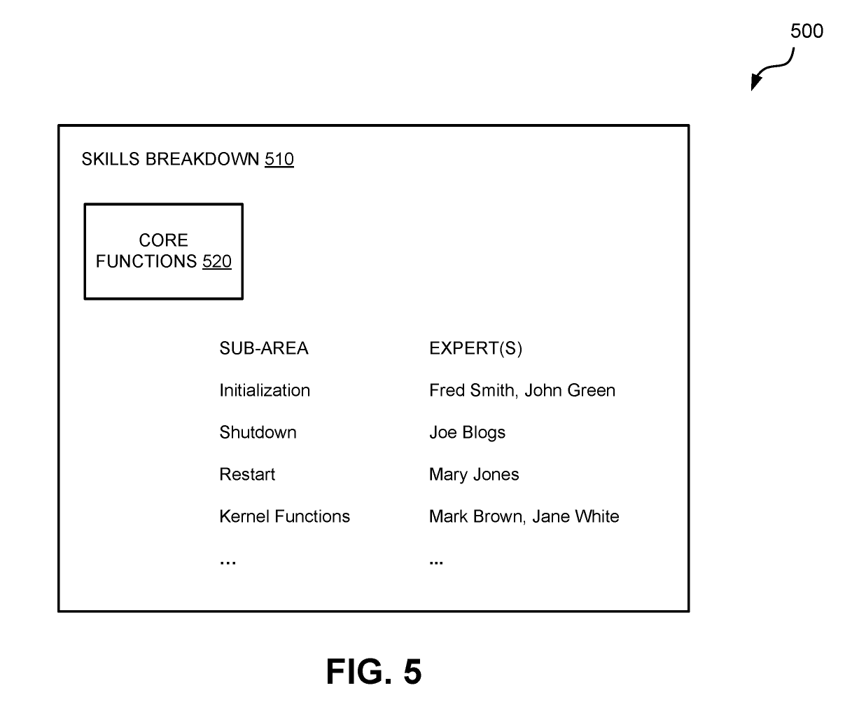

In various embodiments, skills map 410 includes product areas: core functions 420, networking 425, web services 430, performance 435, data management 440, diagnostics 445, terminal control 450, workload management 455, security 460, recovery 465, web services 470, and kernel 475. These product areas are example product areas, and the skills map 410 is not limited to these product areas. Skills map 410 may include any product areas known in the art. In some embodiments, each product area is displayed in a color in order to indicate skill level. For example, core functions 420, web services 430, data management 440, terminal control 450, security 460, and web services 470 may be displayed in yellow to represent a moderate skill level. Networking 425, performance 435, diagnostics 445, and workload management 455 may be displayed in green to represent a good or excellent skill level. Recovery 465 and kernel 475 may be displayed in red to represent a poor skill level. In other embodiments, the skill factor for each product area is displayed with the product area. Additional information may be displayed with each product area, as discussed herein and depicted in FIG. 5.

Referring to FIG. 5, a schematic diagram 500 of a sample skills breakdown 510 is depicted, according to various embodiments. Skills breakdown 510 may be displayed directly on skills map 410 (FIG. 4), in some embodiments. In other embodiments, skills breakdown 510 may be displayed after selecting, or hovering a cursor over a specific product area. Skills breakdown 510 is a skills breakdown of the product area core functions 520, which may correspond to core functions 420 (FIG. 4). Core functions 520 may have various programs, or sub-areas such as initialization, shutdown, restart, kernel functions, etc. In some embodiments, as depicted, recommended users (or experts) are displayed for each program. In other embodiments, a program skill level is displayed for each program. Skills breakdown 510 may further include a user skill factor for each user.

Referring to FIG. 6, computer system 600 is a computer system/server 602 is shown in the form of a general-purpose computing device, according to various embodiments. The components of computer system/server 602 may include, but are not limited to, one or more processors or processing units 610, a system memory 660, and a bus 615 that couple various system components including system memory 660 to processor 610.

Bus 615 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media.

System memory 660 can include computer system readable media in the form of volatile memory, such as random access memory (RAM) 662 and/or cache memory 664. Computer system/server 602 may further include other removable/non-removable, volatile/non-volatile computer system storage media. By way of example only, storage system 665 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 615 by one or more data media interfaces. As will be further depicted and described below, memory 660 may include at least one program product having a set (e.g., at least one) of program modules that are configured to carry out the functions of embodiments of the invention.

Program/utility 668, having a set (at least one) of program modules 669, may be stored in memory 660 by way of example, and not limitation, as well as an operating system, one or more application programs, other program modules, and program data. Each of the operating system, one or more application programs, other program modules, and program data or some combination thereof, may include an implementation of a networking environment. Program modules 669 generally carry out the functions and/or methodologies of embodiments of the invention as described herein.

Computer system/server 602 may also communicate with one or more external devices 640 such as a keyboard, a pointing device, a display 630, etc.; one or more devices that enable a user to interact with computer system/server 602; and/or any devices (e.g., network card, modem, etc.) that enable computer system/server 602 to communicate with one or more other computing devices. Such communication can occur via Input/Output (I/O) interfaces 620. Still yet, computer system/server 602 can communicate with one or more networks such as a local area network (LAN), a general wide area network (WAN), and/or a public network (e.g., the Internet) via network adapter 650. As depicted, network adapter 650 communicates with the other components of computer system/server 602 via bus 615. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electronic signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object orientated program language such as Smalltalk, C++, or the like, and procedural programming languages, such as the “C” programming language or similar programming languages. The computer readable program instructions may execute entirely one the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
receiving change data from a first computing device, the change data comprising at least one of change sets, check-in history, and product areas;
analyzing the change data;
in response to analyzing the change data, determining dimensions of change associated with a change made to a software product, the dimensions of change comprising at least a size of the change, an age of the change, and a quantity of changes;
calculating a program skill level for each program within a product area using the dimensions of the change, the software product having one or more product areas, each product area having one or more programs;
calculating a product skill level for the product area using the calculated program skill levels for each program; and
providing an output having a visual representation of the skill level for the product area.

2. The method of claim 1, wherein calculating the program skill level comprises:
determining at least the size of change and the age of change for each module of a program from the one or more programs, each program having one or more modules;
determining a weighting factor for each module;
calculating a module skill level for each module of the program using at least the size of change, age of change, and the weighting factor; and
calculating a summation of the module skill levels.

3. The method of claim 2, wherein the weighting factor indicates an importance of a module.

4. The method of claim 1, wherein calculating the program skill level comprises:
determining at least the size of change and the age of change for each user of one or more users of a program from the one or more programs;
determining a weighting factor for each user of the program;
calculating a user skill level for each user of the program using at least the size of change, age of change, and the weighting factor; and
calculating a summation of the user skill levels.

5. The method of claim 4, wherein the weighting factor indicates a difficulty of coding.

6. The method of claim 4, wherein the output further includes a recommendation of users for the product area, the recommendation of users indicating one or more users with a high user skill level.

7. The method of claim 4, wherein the output further includes the user skill level for each user.

8. The method of claim 4, wherein the one or more users are at least one of designers and coders of the program.

9. The method of claim 8, wherein the change data further comprises subjective skill data for each of the one or more users, the subjective skill data including subjective user skill levels.

10. The method of claim 9, wherein calculating the program skill level further comprises:
determining the subjective skill data for each user of the program; and
calculating the user skill level for each user of the program further using the subjective skill data.

11. The method of claim 1, wherein the first computing device is a source code management system.

12. The method of claim 1, wherein the visual representation is a skills map.

13. A system having one or more computer processors, the system configured to:
receive change data from a first computing device, the change data comprising at least one of change sets, check-in history, and product areas;
analyze the change data;
in response to analyzing the change data, determine dimensions of change associated with a change made to a software product, the dimensions of change comprising at least a size of the change, an age of the change, and a quantity of changes;
calculate a program skill level for each program within a product area using the dimensions of the change, the software product having one or more product areas, each product area having one or more programs;
calculate a product skill level for the product area using the calculated program skill levels for each program; and
provide an output having a visual representation of the skill level for the product area.

14. The system of claim 13, wherein calculating the program skill level comprises:
determining at least the size of change and the age of change for each module of a program from the one or more programs, each program having one or more modules;
determining a weighting factor for each module;
calculating a module skill level for each module of the program using at least the size of change, age of change, and the weighting factor; and
calculating a summation of the module skill levels.

15. The system of claim 13, wherein calculating the program skill level comprises:
determining at least the size of change and the age of change for each user of one or more users of a program from the one or more programs;
determining a weighting factor for each user of the program;
calculating a user skill level for each user of the program using at least the size of change, age of change, and the weighting factor; and
calculating a summation of the user skill levels.

16. The system of claim 15, wherein the one or more users are at least one of designers and coders of the program.

17. The system of claim 16, wherein the change data further comprises subjective skill data for each of the one or more users, the subjective skill data including subjective user skill levels.

18. A computer program product comprising a non-transitory computer readable storage medium having program instructions embodied therewith, the program instructions executable by a processor of a second computing device to cause the second computing device to perform a method comprising:
receiving change data from a first computing device, the change data comprising at least one of change sets, check-in history, and product areas;
analyzing the change data;
in response to analyzing the change data, determining dimensions of change associated with a change made to a software product, the dimensions of change comprising at least a size of the change, an age of the change, and a quantity of changes;
calculating a program skill level for each program within a product area using the dimensions of the change, the software product having one or more product areas, each product area having one or more programs;
calculating a product skill level for the product area using the calculated program skill levels for each program; and
providing an output having a visual representation of the skill level for the product area.

19. The computer program product of claim 18, wherein calculating the program skill level comprises:
determining at least the size of change and the age of change for each module of a program from the one or more programs, each program having one or more modules;
determining a weighting factor for each module;
calculating a module skill level for each module of the program using at least the size of change, age of change, and the weighting factor; and
calculating a summation of the module skill levels.

20. The computer program product of claim 18, wherein calculating the program skill level comprises:
determining at least the size of change and the age of change for each user of one or more users of a program from the one or more programs;
determining a weighting factor for each user of the program;
calculating a user skill level for each user of the program using at least the size of change, age of change, and the weighting factor; and
calculating a summation of the user skill levels.
